(19) United States
(12) Patent Application Publication
(10) Pub. No.: US 2003/0137276 A1
(43) Pub. Date: Jul. 24, 2003

(54) Travel charger for cellular telephone

(76) Inventor: James Lin, Chung Ho City (TW)

Correspondence Address: Elliott N. Kramsky, Esq., Suite 400, 5850 Canoga Avenue, Woodland Hills, CA, 91367, US

(21) Appl. No.: 10/287,952

(22) Filed: Nov. 4, 2002

(30) Foreign Application Priority Data
Jan. 18, 2002 (TW) 091208482

(51) Int. Cl. H02J 7/00

(52) U.S. Cl. 320/115

(57) ABSTRACT

A travel charger for a cellular telephone mainly comprises a power supply, flat blade rotator body, connection head, all these elements are assembled together with a main body to integrate into one body. Thereby, the travel charger according to the present invention is more streamline, easier to carry and store. And, the charger can be kept in stable electrical connection with each kind of socket, not matter what the direction and the location of the socket is.

### TECHNICAL FIELD

The present invention relates to a travel charger, and more particularly to a travel charger for a cellular telephone that is integrated into one body and has a flat blades rotator body mobile in multiple directions.

### TECHNICAL BACKGROUND

The power supply of the typical structure of a traditional travel charger is built in a big module. Two fixed flat blades disposed in the module are inserted into the holes of a socket, and then, one end of a electric wire with a certain length installed in the module is connected to the power supply, and another end thereof is connected to the connecting head disposed on the module so as to charge a cellular telephone.

The conventional plug device is fixed on the module and projects out of the main body so that it occupies space. Furthermore, the long and exposed wire not only causes inconvenience in storing and carrying, but also the power supply may be fallen off the connection part of the socket to cause electricity to be terminated if the long wire is pulled and dragged by an accident external force while a connection is built between the power supply and the socket. And more serious is that the cellular telephone is fallen down from a higher place to cause damage.

### SUMMARY OF THE PRESENT INVENTION

A travel charger for a cellular telephone according to the present invention mainly comprises a big module type main body on which a connection head is disposed to provide an electricity connection with a cellular telephone so that the cellular telephone can be stood firmly thereon, a set of multi-directionally rotatable flat heads set that can be plugged in a wall type socket and floor type socket, and a protection cover used to protect the charger from dust while it is not in use. Therefore, the whole charger looks streamline and easier to be carried and stored.

Therefore, the main object of the present invention is to provide a travel charger for a cellular telephone to build a power supply, circuit, flat blades rotator body and connection head into one body to reduce a lot of unnecessary installment.

Another object of the present invention is to provide a travel charger for a cellular telephone. A flat blades rotator body, which can be rotated in various directions, is disposed in the charger in order to fit all kind of sockets with different shapes, and the cellular telephone can be stood firmly thereon so as to complete the cellular telephone charging procedure smoothly.

Another object of the present invention is to provide a travel charger for a cellular telephone. A cover, which is convenient in covering and uncovering, is furnished to prevent dust from covering the metal parts of the charger to cause oxidation when the charger is not in use. Therefore, the whole body has sense of integration and looks streamline, and it is easy for a user to carry and store.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 is a prospective view of a preferred embodiment according to the present invention, showing a state that a protection cover is covered on a main body of a travel charger for a cellular telephone;

FIG. 2 is a prospective view of a preferred embodiment according to the present invention, showing a state that a protection cover is separated from a main body of a travel charger for a cellular telephone;

FIG. 3 is a prospective view, showing that a main body is separated from a flat blades rotator body;

FIG. 4 is an explosive view, showing elements of a flat blades rotator body;

FIG. 5 is a prospective view, showing a structure that flat blades are connected to a flat blades fixer seat;

FIG. 6 is a schematic view, showing a fixer seat is rotated around a fulcrum in a main body of a charger;

FIG. 7 is a prospective view, showing a practical state that a charger according to the present invention is plugged into a wall type socket; and

FIG. 8 is a prospective view, showing a practical state that a charger according to the present invention is plugged into a floor type socket.

### DETAILED DESCRIPTION OF THE PRESENT INVENTION

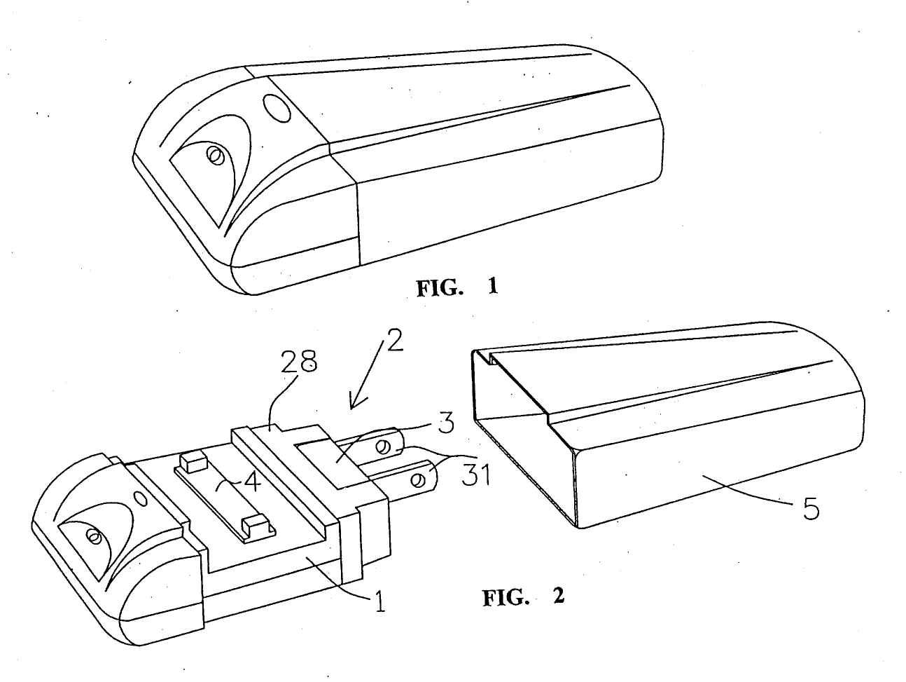

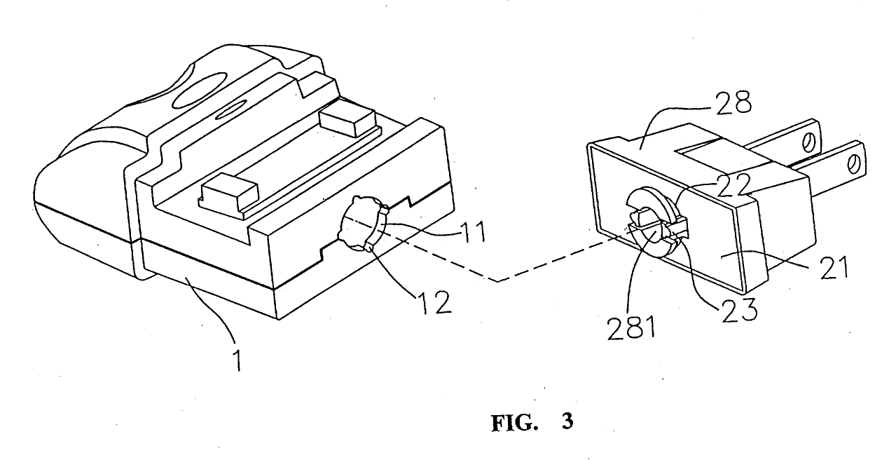

First, please refer to FIGS. 1 and 2. As the figures show, a travel charger for a cellular telephone comprises a main body 1, flat blades rotator body 2 and a protection cover 5. A connection head 4 is disposed on the main body 1. A PCB, transformer, circuits (not shown in the figure), and etc., constitute a power supply. The flat blades rotator body 2, which is combined with the main body, mainly comprises a flat blades base seat 28, flat blades fixer seat 3 and flat blades 31. And, the main body 1, the connection head 4, the protection cover 5 can have many different types and shapes to fit various particular design requirements, and the flat blades can also have other different types and shapes to match up with the number and the shape of electric forks in a socket.

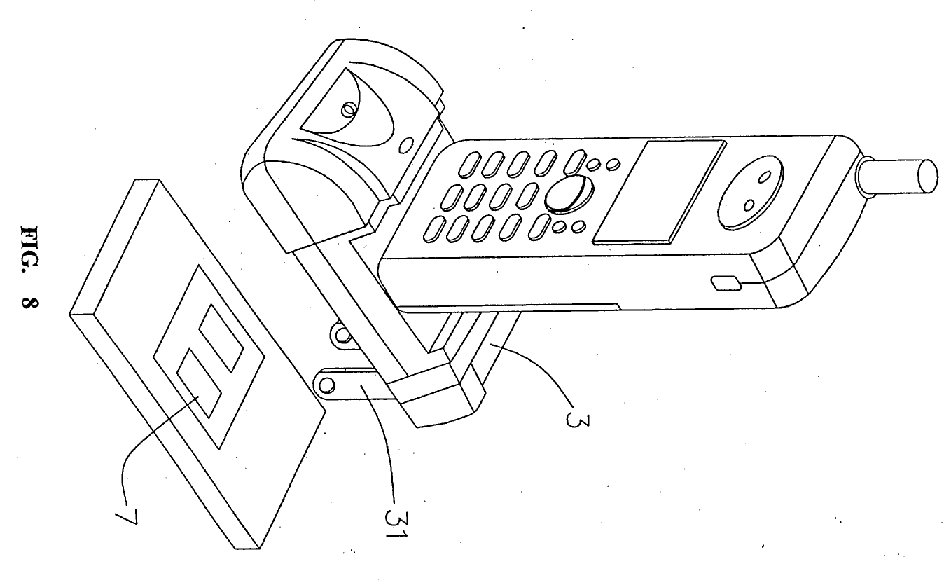

Next, please refer to FIG. 3, which shows individual structures of the main body 1 and the flat blades rotator body 2. The figure shows that a rotating face 21 is disposed on the flat blades base seat 28 of the flat blades rotator body 2 at a place that the base seat 28 contacts with the main body 1. A through hole 281 is opened at the center of the rotating face 21. Further, symmetrical arc type rims 22 are disposed along the circumference of the hole 281. And a positioning pin 23 is located between the two adjacent rims 22. Here, the rims 22 can be received in a axial hole 11 of the main body 1, as shown in FIG. 7. This allows the flat blades base seat 28 to rotate. The base seat 28 can be fixed at a direction when it is forced to rotate to a certain angle by engaging the position pin 23 on the rotating face 21 with position grooves 12 around the axial hole 11.

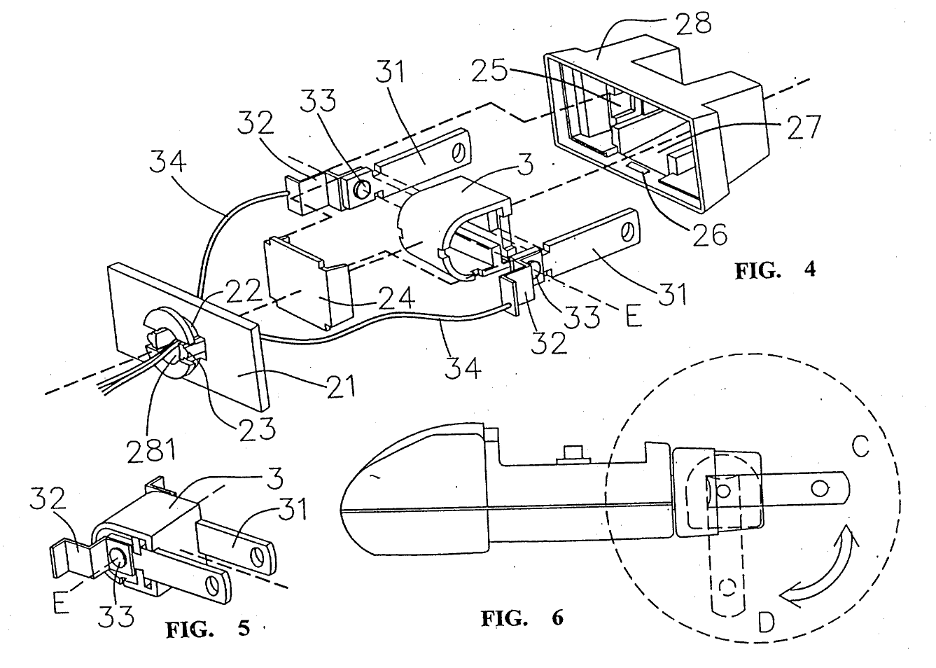

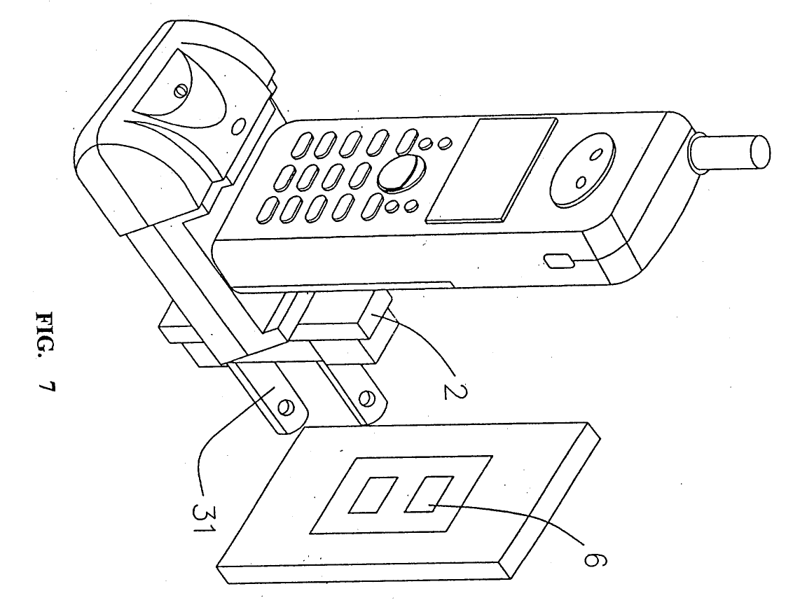

Now, please refer to FIG. 4. The FIG. 4 shows the assembly relationship among the flat blades base seat 28, the flat blades fixer seat 3 and other corresponding elements. The flat blades 31 are fixed to metal plates 32 through rivet 33, and then, combined with the flat blades fixer seat 3 to form a structure shown in FIG. 5. A retaining plate 24 is forced into retaining checks 26 disposed at the upper side of the base seat 28, and further, the metal plates 32 are pressed down to fix them in fixing grooves 25, and the flat blades is passed through the through hole 27. One end of an electric wire 34 is fixed on the metal plate 32 by welding, and another end thereof is passed through the through hole 281. And then, the base seat 28 and the rotating face 21 are bonded together. As FIGS. 4, 5 and 6 show, the flat blades fixer seat 3 can drive the flat blades to rotate around the axis center of the rivet 33 after the metal plates are fixed in the fixing grooves 25. As FIG. 6 shows, the flat blades can be driven from a position C to a position D.

FIG. 7 shows a practical state that a charger according to the present invention is plugged into a wall type socket 6. A cellular telephone is placed on the connection head 4. The flat blades 31 can be inserted into the wall type socket 6 when the flat blades rotator body 2 is rotated to the position shown in the figure.

FIG. 8 shows another practical state that a charger according to the present invention is plugged into a floor type socket 7. The flat blades 31 can be inserted into the floor type socket 12 by rotating the flat blades fixer seat 3 to the position D shown in the FIG. 6.

It is noted that the travel charger for a cellular telephone described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

What is claimed is:

1. A travel charger for a cellular telephone, mainly comprising:
a power supply, constituted by a PCB and electric elements, utilized to attain voltage transformation and stabilizing function to charge a cellular telephone;
a circuit;
a flat blades rotator body, having a set of flat blades, utilized to insert into holes of a socket;
a connection head, utilized to receive said cellular telephone to process charging;
wherein said connection head and said circuit are disposed inside a main body, said flat blades rotator body engaged with said main body, said connection head disposed on said main body and said main body are integrated into one body so that a wire connection is unnecessary.

2. The charger of claim 1, wherein said flat blades rotator is a mechanism that can be rotated in multiple directions so as to be able to inserted in a wall type socket or floor type socket.

3. The charger of claim 2, wherein said flat blades rotator body comprises not only said flat blades, but also a flat blades base seat and flat blades fixer seat; said flat blades base seat is rotatably engaged with said main body, and one end of said flat blades fixer seat receives said flat blades and another end thereof is connected to said flat blades base seat.

4. The charger of claim 3, wherein said flat blades fixer seat is rotatably connected to said flat blades base seat so as to drive said flat blades to rotate.

5. The charger of claim 1, further comprising a protection cover to cover said main body while storing or carrying said charger if said charger is not in use.
